(19) United States
(12) Patent Application Publication
(10) Pub. No.: US 2022/0318903 A1
(43) Pub. Date: Oct. 6, 2022

(54) MACHINE LEARNING BASED PREDICTION FOR MULTIPLE CURRENCY GOALS

(71) Applicant: Intuit Inc., Mountain View, CA (US)

(72) Inventor: Puja Baid, Marina Del Rey, CA (US)

(73) Assignee: Intuit Inc., Mountain View, CA (US)

(21) Appl. No.: 17/219,572

(22) Filed: Mar. 31, 2021

(51) Int. Cl. G06Q 40/04; G06Q 30/02; G06N 20/00

(52) U.S. Cl. CPC G06Q 40/04; G06Q 30/0202; G06N 20/00

(57) ABSTRACT

Systems and methods for predicting multi-currency goals are disclosed. An example method may include receiving a multi-currency goal, the multi-currency goal including at least a current value of an account in a first currency, a target value, and one or more target currencies, predicting one or more future values of the account using a first machine learning model, predicting an inflation-adjusted future currency exchange rate (IAFCER) for each predicted future value of the account for each of the one or more target currencies using one or more second machine learning models, determining, for each predicted IAFCER, an equivalent target amount in the corresponding target currency, and predicting whether the multi-currency goal will succeed or fail based at least in part on the predicted future values of the account and the equivalent target amounts.

### TECHNICAL FIELD

This disclosure relates generally to prediction of goals using machine learning, and more particularly to predicting savings goals involving multiple currencies.

### DESCRIPTION OF RELATED ART

Users of financial planning software may wish to establish personal savings goals. A user may desire assistance with planning such goals due to various complications. For example, it may be difficult for a user to predict future values of their own savings. Such goals may be further complicated by the involvement of multiple currencies, for example due to the complications of predicting future exchange rates, current and future differences in cost of living, future differences in rates of inflation, and so on.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for predicting multi-currency goals. The method may be performed by a computing device associated with one or more machine learning models and include receiving a multi-currency goal, the multi-currency goal including at least a current value of an account in a first currency, a target value, and one or more target currencies, predicting one or more future values of the account using a first machine learning model, predicting an inflation-adjusted future currency exchange rate (IAFCER) for each predicted future value of the account for each of the one or more target currencies using one or more second machine learning models, determining, for each predicted IAFCER, an equivalent target amount in the corresponding target currency, and predicting whether the multi-currency goal will succeed or fail based at least in part on the predicted future values of the account and the equivalent target amounts.

In some aspects, the first machine learning model is trained with training data including previous values of the account. In some aspects, determining the IAFCER includes predicting, for each predicted future value of the account, a future currency exchange rate (CER) for each of the target currencies. In some aspects, the future CERs may be determined previously and subsequently retrieved. In some aspects, the future CERs may be predicted using one or more machine learning models trained based at least in part on a series of historical values of the exchange rates between the first currency and the target currencies. In some aspects, determining the IAFCER includes predicting, for each predicted future value of the account, a future consumer price index (CPI) for each of the target currencies. In some aspects, the future CPIs may be predicted using one or more machine learning models trained based at least in part on a series of historical values of the CPI associated with each of the target currencies. In some aspects, the IAFCERs are determined based at least in part on the predicted future CERs and the predicted future CPI for each target currency. In some aspects, the IAFCERs are determined using one or more machine learning models trained using training data including previous values of the inflation-adjusted currency exchange rate for each of the target currencies.

In some aspects, predicting whether or not the multi-currency goal will succeed or fail includes predicting that the multi-currency goal will fail in response to the predicted account values, when converted to each of the target currencies, not exceeding any of the corresponding equivalent target amounts. In some aspects, predicting whether or not the multi-currency goal will succeed or fail includes predicting that the multi-currency goal will succeed in response to at least one of the predicted account values, when converted to a respective target currency, exceeds a corresponding equivalent target amount prior to a target date associated with the multi-currency goal. In some aspects, in response to predicting that the multi-currency goal will succeed, the method may further include indicating one or more dates associated with the predicted account values which exceed the corresponding equivalent target amount.

In some aspects, predicting the one or more future values of the account includes periodically predicting a future value of the account. In some aspects, periodically predicting the future values includes predicting a future value daily.

Another innovative aspect of the subject matter described in this disclosure can be implemented in a system for predicting multi-currency goals. An example system includes one or more processors, and a memory storing instructions for execution by the one or more processors. Execution of the instructions causes the system to perform operations including receiving a multi-currency goal, the multi-currency goal including at least a current value of an account in a first currency, a target value, and one or more target currencies, predicting one or more future values of the account using a first machine learning model, predicting an inflation-adjusted future currency exchange rate (IAFCER) for each predicted future value of the account for each of the one or more target currencies using one or more second machine learning models, determining, for each predicted IAFCER, an equivalent target amount in the corresponding target currency, and predicting whether the multi-currency goal will succeed or fail based at least in part on the predicted future values of the account and the equivalent target amounts.

In some aspects, the first machine learning model is trained with training data including previous values of the account. In some aspects, determining the IAFCER includes predicting, for each predicted future value of the account, a future currency exchange rate (CER) for each of the target currencies. In some aspects, the future CERs may be determined previously and subsequently retrieved. In some aspects, the future CERs may be predicted using one or more machine learning models trained based at least in part on a series of historical values of the exchange rates between the first currency and the target currencies. In some aspects, determining the IAFCER includes predicting, for each predicted future value of the account, a future consumer price index (CPI) for each of the target currencies. In some aspects, the future CPIs may be predicted using one or more machine learning models trained based at least in part on a series of historical values of the CPI associated with each of the target currencies. In some aspects, the IAFCERs are determined based at least in part on the predicted future CERs and the predicted future CPI for each target currency. In some aspects, the IAFCERs are determined using one or more machine learning models trained using training data including previous values of the inflation-adjusted currency exchange rate for each of the target currencies.

In some aspects, predicting whether or not the multi-currency goal will succeed or fail includes predicting that the multi-currency goal will fail in response to the predicted account values, when converted to each of the target currencies, not exceeding any of the corresponding equivalent target amounts. In some aspects, predicting whether or not the multi-currency goal will succeed or fail includes predicting that the multi-currency goal will succeed in response to at least one of the predicted account values, when converted to a respective target currency, exceeds a corresponding equivalent target amount prior to a target date associated with the multi-currency goal. In some aspects, in response to predicting that the multi-currency goal will succeed, the method may further include indicating one or more dates associated with the predicted account values which exceed the corresponding equivalent target amount.

In some aspects, predicting the one or more future values of the account includes periodically predicting a future value of the account. In some aspects, periodically predicting the future values includes predicting a future value daily.

Another innovative aspect of the subject matter described in this disclosure can be implemented in a non-transitory computer-readable storage medium storing instructions for execution by one or more processors of a system coupled to one or more machine learning models. Execution of the instructions causes the system to perform operations including receiving a multi-currency goal, the multi-currency goal including at least a current value of an account in a first currency, a target value, and one or more target currencies, predicting one or more future values of the account using a first machine learning model, predicting an inflation-adjusted future currency exchange rate (IAFCER) for each predicted future value of the account for each of the one or more target currencies using one or more second machine learning models, determining, for each predicted IAFCER, an equivalent target amount in the corresponding target currency, and predicting whether the multi-currency goal will succeed or fail based at least in part on the predicted future values of the account and the equivalent target amounts.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a multi-currency goal prediction system, according to some implementations.

FIG. 2 shows a high-level overview of an example process flow that may be employed by the multi-currency goal prediction system of FIG. 1.

FIG. 3 shows an illustrative flow chart depicting an example operation for predicting multi-currency goals, according to some implementations.

Like numbers reference like elements throughout the drawings and specification.

### DETAILED DESCRIPTION

Implementations of the subject matter described in this disclosure may be used to assist users with the planning of financial goals involving multiple different currencies (“multi-currency goals”) using a number of trained machine learning models. One example type of multi-currency goal may be a user planning to retire and considering whether and when they can afford to retire in any of a number of different countries. Such a user may wish to know whether their goals are likely to succeed in light not only their own savings but inflation and currency exchange rates. Accordingly, implementations may be used to predict not only future values of the user's accounts, but also inflation-adjusted future currency exchange rates (IAFCERs) for each of a number of different currencies associated with the multi-currency goal. For example, various implementations disclosed herein may allow a user to establish a goal in one or more target currencies including a target amount and a target date. The machine learning models may predict future values of the user's accounts for a number of dates prior to the target date. The machine learning models may also predict corresponding IAFCERs for each target currency and predict whether the goal will fail or succeed in any of the target currencies before the target date has passed. These and other aspects of the example implementations are discussed further below.

Various implementations of the subject matter disclosed herein provide one or more technical solutions to the technical problem of predicting the success of personal goals involving multiple currencies. Example implementations may predict a future value of a user's accounts at one or more future dates using one or more trained machine learning models. Further, example implementations may predict, using one or more machine learning models, an IAFCER for each of the future dates in each of a number of target currencies. For example, predicting the IAFCERs may include predicting a future currency exchange rate (CER) for each target currency on the future dates using one or more machine learning models. Predicting the IAFCERs may also include predicting a consumer price index on the future dates using one or more machine learning models. Example implementations may then predict whether the multi-currency goal will succeed or fail based on the predicted future values of the user's account and the predicted IAFCERs. More specifically, various aspects of the present disclosure provide a unique computing solution to a unique computing problem that did not exist prior to electronic user assistance systems that can aid users in establishing multi-currency goals. As such, implementations of the subject matter disclosed herein are not an abstract idea such as organizing human activity or a mental process that can be performed in the human mind.

Moreover, various aspects of the present disclosure effect an improvement in the technical field of predicting the success or failure of multi-currency goals in light of exchange rates, inflation, and other complicating factors. The use of machine learning models trained based on historical exchange rates, consumer price indices, and so on, may allow for more accurate prediction of the success or failure of such goals, allowing for users to establish goals likely to succeed. Training machine learning models and using such trained machine learning models for predicting the success or failure of multi-currency goals cannot be performed in the human mind, much less using pen and paper. In addition, implementations of the subject matter disclosed herein are usable with a wide variety of computing applications, and do far more than merely create contractual relationships, hedge risks, mitigate settlement risks, and the like, and therefore cannot be considered a fundamental economic practice.

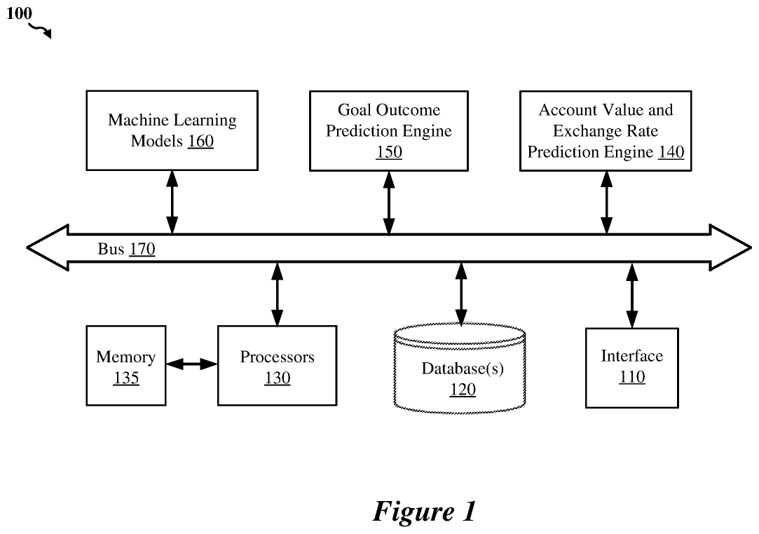

FIG. 1 shows a multi-currency goal prediction system 100, according to some implementations. Various aspects of the multi-currency goal prediction system 100 disclosed herein may be applicable for predicting the success or failure of multi-currency goals using one or more trained machine learning models in a variety of computing applications. Such functionality may be useful for assisting users in establishing achievable multi-currency goals in a wide variety of applications, such as retirement planning applications, financial planning applications, relocation assistance applications and so on.

The multi-currency goal prediction system 100 is shown to include an input/output (I/O) interface 110, a database 120, one or more data processors 130, a memory 135 coupled to the data processors 130, an account value and exchange rate prediction engine 140, a goal outcome prediction engine 150, and one or more machine learning models 160. In some implementations, the various components of the multi-currency goal prediction system 100 may be interconnected by at least a data bus 170, as depicted in the example of FIG. 1. In other implementations, the various components of the multi-currency goal prediction system 100 may be interconnected using other suitable signal routing resources.

The interface 110 may include a screen, an input device, and other suitable elements that allow a user to provide information to the multi-currency goal prediction system 100 and/or to retrieve information from the multi-currency goal prediction system 100. Example information that can be provided to the multi-currency goal prediction system 100 may include configuration information for the multi-currency goal prediction system 100, such as information for configuring the account value and exchange rate prediction engine 140 or goal outcome prediction engine 150, training data or one or more trained machine learning models for the machine learning model 160, historical exchange rate date, historical consumer price indices, historical user account values, historical user expenses, or the like. For example, such historical data may be retrieved from one or more data sources such as the International Monetary Fund (IMF), The World Bank, and so on. Example information that can be retrieved from the multi-currency goal prediction system 100 may include predictions of goal success or failure and associated data generated by the trained machine learning models 160 or goal outcome prediction engine 150, one or more trained machine learning models, one or more goal success or failure prediction alerts, configuration information for the multi-currency goal prediction system 100, and the like.

The database 120, which may represent any suitable number of databases, may store any suitable information pertaining to configuration of the multi-currency goal prediction system 100, to users of the multi-currency goal prediction system 100. For example, the information may include configuration information for training one or more of the machine learning models, historical data such as historical user account value data, historical consumer price index data, historical exchange rate data, and so on, may include configuration information for the machine learning model 160. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data sets stored in the database 120), may be one or more suitable processors capable of executing scripts or instructions of one or more software programs stored in the multi-currency goal prediction system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non-volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The account value and exchange rate prediction engine 140 may predict future values of user accounts, future consumer price indices (CPIs), future currency exchange rates (CERs), and inflation-adjusted future currency exchange rates (IAFCERs) using the machine learning models 160. For example, training data or configuration information for the machine learning models may be retrieved from the database 120, from another memory coupled to the multi-currency goal prediction system 100, or via one or more networks coupled to the multi-currency goal prediction system 100 and used to train or configure the machine learning models 160 for predicting the future values of the user accounts, future CPIs, future CERs, and IAFCERs. As discussed in more detail below, the account value and exchange rate prediction engine 140 may predict these quantities in connection with the prediction of the success or failure of users' multi-currency goals.

The goal outcome prediction engine 150 may be used to predict the success or failure of users' multi-currency goals using the account value and exchange rate prediction engine 140 and the trained machine learning models 160. As discussed further below, the goal outcome prediction engine 160 may receive information about a user's multi-currency goal, for example information about the user's accounts, one or more target currencies, a target amount, and a target date. For example, this information may be retrieved from the database 120 or another memory coupled to the multi-currency goal prediction system 100 or provided by the user using the interface 110 or another user interface coupled to the multi-currency goal prediction system 100. The goal outcome prediction engine 150 may predict whether or not the user will be able to save an equivalent amount to the target amount in any of the target currencies by the target date. This prediction may be based in part on the predicted future values of the user's accounts, the future CPIs, future CERs, and IAFCERs predicted by the account value and exchange rate prediction engine 140 using the trained machine learning models 160. The user may be informed of the predicted success or failure, for example, so that the user may adjust the parameters of the multi-currency goal, if failure is predicted, or so that the user may begin working toward achievement of the multi-currency goal, if success is predicted.

The machine learning models 160 may include any number of machine learning models that can be trained, using training data retrieved from the database 120 or another memory coupled to the multi-currency goal prediction system 100, to predict future values of user accounts, future CPIs, future CERs, and IAFCERs. A machine learning model can take the form of an extensible data structure that can be used to represent sets of words or phrases and/or can be used to represent sets of attributes or features. The machine learning models may be trained with appropriate training data. For example, training data for predicting future values of the user accounts may be based on previous values of the user's accounts, historical account values for other users, historical expense, and income data for the user or for similar users, and so on. Training data for predicting future CPIs in a given target currency may be based on previous CPIs for that target currency, other economic indicators affecting consumer prices in that target currency, and so on. Training data for predicting future CERs for a given target currency may include historical values of the CER for that target currency, other economic indicators affecting exchange rates for that target currency, and so on. Training data for predicting IAFCERs in a given target currency may be based on historical values of the IAFCER for that target currency, other similar economic data, and corresponding values of the CPI and CER for that target currency. In some implementations, the machine learning models 160 may include deep neural networks (DNNs), which may have any suitable architecture, such as a feedforward architecture or a recurrent architecture. For example, as discussed below, the machine learning models 160 may include regression models, K-nearest neighbors models, auto regressive integrated moving average (ARIMA) based models, random forest models, long short-term memory (LSTM) models, and so on.

The particular architecture of the multi-currency goal prediction system 100 shown in FIG. 1 is but one example of a variety of different architectures within which aspects of the present disclosure may be implemented. For example, in other implementations, the multi-currency goal prediction system 100 may not include the account values and exchange rate prediction engine 140, the functions of which may be implemented by the processors 130 executing corresponding instructions or scripts stored in the memory 135. In some other implementations, the functions of the goal outcome prediction engine 150 may be performed by the processors 130 executing corresponding instructions or scripts stored in the memory 135. Similarly, the functions of the machine learning models 160 may be performed by the processors 130 executing corresponding instructions or scripts stored in the memory 135.

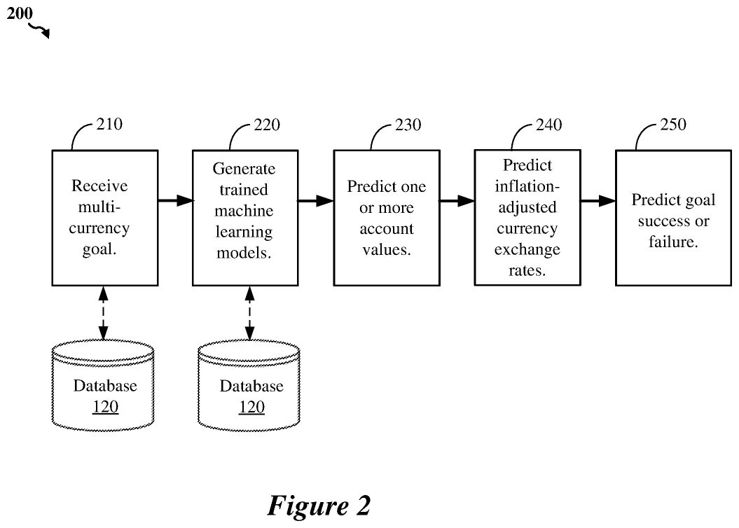

FIG. 2 shows a high-level overview of an example process flow 200 that may be employed by the multi-currency goal prediction system 100 of FIG. 1. In block 210, the multi-currency goal prediction system 100 receives a multi-currency goal, for example the multi-currency goal may be received from a user via the interface 110 or retrieved from the database 120 or another memory coupled to the multi-currency goal prediction system 100. The multi-currency goal may include at least a current value of a user account in a first currency, a target value of the account, and one or more target currencies. In block 220, the multi-currency goal prediction system 100 generates one or more trained machine learning models. For example, the trained machine learning models may be generated using configuration or training data retrieved from the database 120 or received via one or more network interfaces coupled to the multi-currency goal prediction system 100. In block 230, one or more future values of the user's accounts may be predicted. For example, the account values may be predicted using one or more trained machine learning models using the account value and exchange rate prediction engine 140. In block 240, an IAFCER may be predicted in each of the target currencies for each of the predicted one or more account values. For example, IAFCERs may be predicted using the account value and exchange rate prediction engine 140 using one or more trained machine learning models 160. At block 250, the goal outcome prediction engine 160 may predict whether the multi-currency goal will succeed or fail.

As discussed above, users' savings goals are increasingly international in nature. For example, a user may wish to invest in one or more countries employing target currencies different from their home country's currency, to retire in such a country, and so on. Planning for the achievement of such multi-currency goals presents additional complications as compared to single currency goals. For example, in addition to estimating the future value of their own savings, users must also account for currency exchange rates between their home currency and the target currencies, understand and account for estimated variations in inflation and pricing in the target currencies, and so on. However, despite the complexity, there may be substantial value in the achievement of such multi-currency goals. For example, due to differences in CPI and currency exchange rates between the home currency and the target currency, as well as differences in cost of living, for example measured using purchasing power parity (PPP) or similar metrics, users may be able to achieve their goals more quickly in some countries as compared to others. If the multi-currency goal is saving for retirement, this may mean a user is able to retire sooner in some countries as compared to others, which may be quite desirable. Accurately predicting the success or failure of such multi-currency goals may allow users to plan and achieve such goals more reliably and more confidently.

The example implementations allow for the success or failure of users' multi-currency goals to be predicted using machine learning. This may aid users in more reliably and confidently planning the successful achievement of such multi-currency goals. More specifically, the example implementations may use machine learning models trained using historical and other data, to predict user account values, CPIs, CERs, and IAFCERs relating to such goals, and to predict the success or failure of the multi-currency goals based on these predicted quantities. Users may employ these predictions in setting achievable multi-currency goals, for example, by increasing their savings in response to a prediction that current savings patterns are predicted to fail to achieve a multi-currency goal.

As discussed above, the example implementations may use machine learning to make predictions relating to multi-currency goals. Such multi-currency goals may include a number of components. For example, a multi-currency goal may include one or more pieces of information relating to a user's accounts, such as savings or checking accounts, and so on. In some implementations, the multi-currency goal may include a current value of one or more accounts, the one or more accounts to be used for achieving the multi-currency goal. In some other implementations, the multi-currency goal may specify a portion, such as a percentage, of the account's value which is to be devoted towards achievement of the multi-currency goal. The multi-currency goal may also specify a first currency associated with the user's accounts. For example, if the user's accounts are held in the U.S., then U.S. dollars may be specified as the first currency. The multi-currency goal may also specify one or more target currencies. Each target currency may be a currency of a country associated with achievement of the multi-currency goal. For example, a user may have a multi-currency goal to retire in one of three countries, and the currency used in each of the three countries may be specified as a target currency. The multi-currency goal may also specify a target amount. In some aspects, the target amount may include a target amount expressed in each of the target currencies, for example differing CPIs and costs of living in the country associated with each target currency may mean that a user's target amount differs depending on the target currency. A multi-currency goal may also specify a target date for achievement of the goal. The multi-currency goal may also specify other information about the goal, such as a goal set date, and one or more actions associated with completion of the goal. Actions associated with completion of the goal may include information relating to funds transfer, instructions to notify the user of completion of the goal, and so on.

After receiving information relating to the multi-currency goal, predicting success or failure of the goal may require prediction of a number of factors on a number of occasions, such as the user's account value and the IAFCER for the first currency (the user's home currency) and for each target currency. In some aspects, each of these factors may be predicted periodically, such as on a daily or weekly basis.

Predicting the future value of the user's account may be performed using a suitable trained machine learning model, of the machine learning models 160, such as a regression-based model, a K-nearest neighbors model, an ARIMA model, a random forest model, and so on. The machine learning model may be trained based on past savings and expenses of the user, on historical savings and expense trends of similar users, or similar training data. In some implementations, a value of the user's account may be predicted daily. In some aspects, the predicted value may be converted into each of the target currencies, for example using the predicted IAFCER for each target currency, as discussed below.

For each predicted value of the user's account, a value of the IAFCER may be predicted for the home currency and each target currency of the multi-currency goal. For example, when the value of the user's account is predicted daily, the IAFCER may also be predicted daily. Predicting the IAFCER for the home currency or a target currency may require prediction of a future CPI and a future CER for that currency. In some aspects, the CER may be predicted using a suitable machine learning model of the machine learning models 160, trained using historical exchange rates for the currency, in addition to other historical information relating to the exchange rate. In some aspects, the machine learning model for predicting the CER may be an LSTM model, a regression-based model, a K-nearest neighbors model, an ARIMA based model, a random forest model, or another suitable machine learning model. The CER may also be predicted daily when the values of the user's account are predicted daily. Predicting the CPI for a currency may be performed using a suitable machine learning model of the machine learning models 160, trained using historical values of the CPI for the currency, in addition to other historical information relating to price indices for the currency. In some aspects, the machine learning model for predicting the CPI may be an LSTM model, a regression-based model, a K-nearest neighbors model, an ARIMA based model, a random forest model, or another suitable machine learning model. Because the actual CPI for a currency/country is often only updated on a monthly basis, in some aspects, the CPI may only be predicted once per month per currency, even when the CER is predicted more often, such as on a daily basis. The predicted CER and CPI for a currency may be used to predict a corresponding value of the IAFCER for that currency. In some aspects, the IAFCER may be a function of the CER and CPI, while in some other aspects another machine learning model of the machine learning models 160 may be used for determining the IAFCER. For example, the machine learning model may be a recurrent neural network, trained based on historical values of the CER and CPI and corresponding historical values of the IAFCER.

In some aspects, the predicted future CERs, CPIs, and IAFCERs for the currencies (the home currency and the target currencies) may be stored, for example in the database 120 for subsequent lookups. In some aspects, these CERs, CPIs, and IAFCERs may be predicted for a number of currencies in advance of reception of the multi-currency goal. For example, the CERs, CPIs, and IAFCERs may be predicted for each of a predetermined number of potential currencies, and for a number of days or months in advance. Then, values of these quantifies may be retrieved from the database 120 for each target currency when predicting the success or failure of a multi-currency goal.

Further, actual CERs, CPIs, and IAFCERs for the currencies may be obtained, for example from a bank or regulatory body associated with each of the currencies, such as from the World Bank, the IMF, or similar. These actual CERs, CPIs, and IAFCERs may also be stored, and used for generating additional training data for the machine learning models. For example, the actual values may be used for calculating accuracy metrics, error metrics, such as root mean squared error (RMSE), and so on.

After information regarding the multi-currency goal is obtained, the values of the user's account predicted, and the values of the IAFCER predicted or obtained from the database 120, the multi-currency goal prediction system 100 may predict whether the multi-currency goal will succeed or fail based on these predicted quantities. More particularly, each predicted IAFCER may be used for calculating an equivalent first currency value for the goal amount in each target currency. That is, the IAFCER may be used to predict what value of the first currency will be equivalent to the target value in the target currency. An example equivalent first currency value may be calculated as (first currency equivalent)=(IAFCER in target currency)*(Target amount in target currency)/(IAFCER in first currency). This first currency equivalent is thus the value in the first currency predicted to meet the target amount in the target currency. In other words, if the user's account value is predicted to meet or exceed this first currency equivalent on any day prior to the target date for the multi-currency goal, then the goal is predicted to succeed. On the other hand, if the user's account value is not predicted to meet or exceed this first currency equivalent on any day prior to the target date, then the multi-currency goal is predicted to fail.

In some aspects, the user may be notified when the multi-currency goal is predicted to fail or to succeed. For example, predicting the success or failure of a multi-currency goal may be performed as a part of the user's establishment of the goal That is, the user may enter the relevant details of their goal, and then the prediction may be made. Alternatively, the user may be notified using another suitable technique, such as email, text message, and so on. In some aspects, the user's multi-currency goal may be predicted to succeed on a number of occasions, such as a number of different days. In some aspects, the user may be notified of each of these occasions. In some other aspects, the user may be notified only of the soonest of these occasions, or only of the occasion where the predicted value of the user's account exceeds the first currency equivalent by the greatest amount.

In some aspects one or more other metrics of goal health may be calculated in addition to predicted success or failure of a multi-currency goal. For example, the predicted value of the user's account and the predicted first currency equivalent may be used to determine a goal percentage, or the proportion of the user's goal predicted to be achieved on each date. For example, a simple proportion may be given as the predicted value of the user's account on a given day divided by the first currency equivalent on that day.

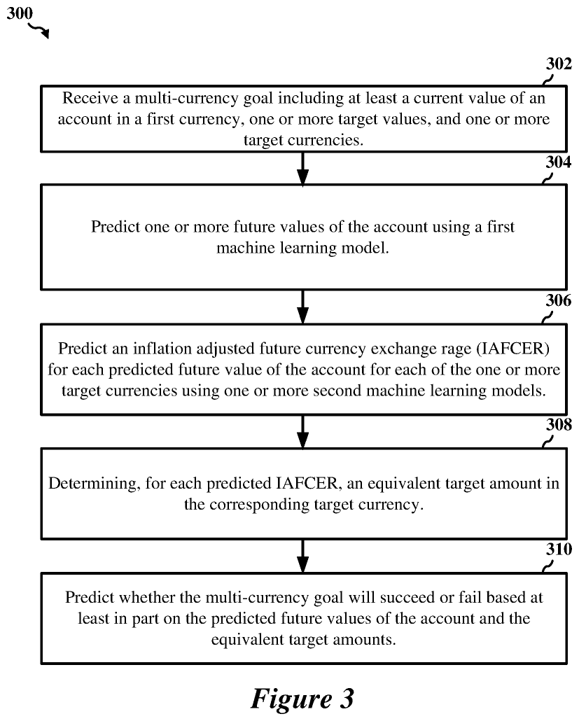

FIG. 3 shows an illustrative flow chart depicting an example operation 300 for predicting multi-currency goals, according to some implementations. The example operation 300 may be performed by one or more processors of a computing device including or associated with one or more machine learning models, such as the multi-currency goal prediction system 100 of FIG. 1. It is to be understood that the example operation 300 may be performed by any suitable systems, computers, or servers.

At block 302, the multi-currency goal prediction system 100 received a multi-currency goal including at least a current value of an account in a first currency, one or more target values, and one or more target currencies. At block 304, the multi-currency goal prediction system 100 predicts one or more future values of the account using a first machine learning model. At block 306, the multi-currency goal prediction system 100 predicts an inflation-adjusted future currency exchange rate (IAFCER) for each predicted future value of the account for each of the one or more target currencies using one or more second machine learning models. At block 308, the multi-currency goal prediction system 100 determines, for each predicted IAFCER, an equivalent target amount in the corresponding target currency. At block 310, the multi-currency goal prediction system 100 predicts whether the multi-currency goal will succeed or fail based at least in part on the predicted future values of the account and the equivalent target amounts.

In some aspects, the first machine learning model is trained with training data including previous values of the account. In some aspects, determining the IAFCER in block 306 includes predicting, for each predicted future value of the account, a future currency exchange rate (CER) for each of the target currencies. In some aspects, the future CERs may be determined previously and retrieved in block 306. In some aspects, the future CERs may be predicted using one or more machine learning models trained based at least in part on a series of historical values of the exchange rates between the first currency and the target currencies. In some aspects, determining the IAFCER includes predicting, for each predicted future value of the account, a future consumer price index (CPI) for each of the target currencies. In some aspects, the future CPIs may be predicted using one or more machine learning models trained based at least in part on a series of historical values of the CPI associated with each of the target currencies. In some aspects, the IAFCERs are determined based at least in part on the predicted future CERs and the predicted future CPI for each target currency. In some aspects, the IAFCERs are determined using one or more machine learning models trained using training data including previous values of the inflation-adjusted currency exchange rate for each of the target currencies.

In some aspects, predicting whether or not the multi-currency goal will succeed or fail in block 310 includes predicting that the multi-currency goal will fail in response to the predicted account values, when converted to each of the target currencies, not exceeding any of the corresponding equivalent target amounts. In some aspects, predicting whether or not the multi-currency goal will succeed or fail includes predicting that the multi-currency goal will succeed in response to at least one of the predicted account values, when converted to a respective target currency, exceeds a corresponding equivalent target amount prior to a target date associated with the multi-currency goal. In some aspects, in response to predicting that the multi-currency goal will succeed, the method may further include indicating one or more dates associated with the predicted account values which exceed the corresponding equivalent target amount.

In some aspects, predicting the one or more future values of the account in block 304 includes periodically predicting a future value of the account. In some aspects, periodically predicting the future values includes predicting a future value daily.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method of predicting multi-currency goals, the method performed by a computing device associated with one or more machine learning models and comprising:
receiving a multi-currency goal, the multi-currency goal including at least a current value of an account in a first currency, one or more target values, and one or more target currencies;
predicting one or more future values of the account using a first machine learning model;
predicting an inflation-adjusted future currency exchange rate (IAFCER) for each predicted future value of the account for each of the one or more target currencies using one or more second machine learning models;
determining, for each predicted IAFCER, an equivalent target amount in the corresponding target currency; and
predicting whether the multi-currency goal will succeed or fail based at least in part on the predicted future values of the account and the equivalent target amounts.

2. The method of claim 1, wherein the first machine learning model is trained with training data comprising previous values of the account.

3. The method of claim 1, wherein determining the IAFCER for each predicted future value of the account comprises predicting, for each predicted future value of the account, a future currency exchange rate (CER) for each of the target currencies.

4. The method of claim 3, wherein the future CERs are predicted using one or more machine learning models trained based at least in part on a series of historical values of the exchange rates between the first currency and the target currencies.

5. The method of claim 3, wherein determining the IAFCER for each predicted future value of the account comprises predicting, for each predicted future value of the account, a future consumer price index (CPI) for each of the target currencies.

6. The method of claim 5, wherein the future CPIs are predicted using one or more machine learning models trained based at least in part on a series of historical values of the CPI associated with the target currencies.

7. The method of claim 5, wherein determining the IAFCER is based at least in part on the predicted future CER and the predicted future CPI for each target currency.

8. The method of claim 7, wherein the IAFCERs are determined using one or more machine learning models trained using training data including previous values of the inflation-adjusted currency exchange rate for each of the target currencies.

9. The method of claim 1, wherein predicting whether or not the multi-currency goal will succeed or fail comprises predicting that the multi-currency goal will fail in response to the predicted account values, when converted to each of the target currencies, not exceeding any of the corresponding equivalent target amounts.

10. The method of claim 1, wherein predicting whether or not the multi-currency goal will succeed or fail comprises predicting that the multi-currency goal will succeed in response to at least one of the predicted account values, when converted to a respective target currency, exceeds a corresponding equivalent target amount prior to a target date associated with the multi-currency goal.

11. The method of claim 10, further comprising, in response to predicting that the multi-currency goal will succeed, indicating one or more dates associated with the predicted account values which exceed the corresponding equivalent target amount.

12. The method of claim 1, wherein predicting the one or more future values of the account comprises periodically predicting a future value of the account.

13. The method of claim 12, wherein periodically predicting the future value of the account comprises predicting the future value of the account once per day.

14. A system for predicting multi-currency goals, the system coupled to one or more machine learning models and comprising:
one or more processors; and
a memory storing instructions that, when executed by the one or more processors, cause the system to perform operations comprising:
receiving a multi-currency goal, the multi-currency goal including at least a current value of an account in a first currency, one or more target values, and one or more target currencies;
predicting one or more future values of the account using a first machine learning model;
predicting an inflation-adjusted future currency exchange rate (IAFCER) for each predicted future value of the account for each of the one or more target currencies using one or more second machine learning models;
determining, for each predicted IAFCER, an equivalent target amount in the corresponding target currency; and
predicting whether the multi-currency goal will succeed or fail based at least in part on the predicted future values of the account and the equivalent target amounts.

15. The system of claim 14, wherein execution of the instructions for determining the IAFCER for each predicted future value of the account causes the system to perform operations further comprising predicting, for each predicted future value of the account, a future currency exchange rate (CER) for each of the target currencies.

16. The system of claim 15, wherein the future CERs are predicted using one or more machine learning models trained based at least in part on a series of historical values of the exchange rates between the first currency and the target currencies.

17. The system of claim 15, wherein execution of the instructions for determining the IAFCER for each predicted future value of the account causes the system to perform operations further comprising predicting, for each predicted future value of the account, a future consumer price index (CPI) for each of the target currencies.

18. The system of claim 17, wherein the future CPIs are predicted using one or more machine learning models trained based at least in part on a series of historical values of the CPI associated with the target currencies.

19. The system of claim 17, wherein the IAFCER determined is based at least in part on the predicted future CER and the predicted future CPI for each target currency.

20. A non-transitory computer-readable storage medium storing instructions that, when executed by one or more processors of a system coupled to one or more machine learning models, causes the system to perform operations comprising:
receiving a multi-currency goal, the multi-currency goal including at least a current value of an account in a first currency, one or more target values, and one or more target currencies;
predicting one or more future values of the account using a first machine learning model;
predicting an inflation-adjusted future currency exchange rate (IAFCER) for each predicted future value of the account for each of the one or more target currencies using one or more second machine learning models;
determining, for each predicted IAFCER, an equivalent target amount in the corresponding target currency; and
predicting whether the multi-currency goal will succeed or fail based at least in part on the predicted future values of the account and the equivalent target amounts.
